(19) United States
(12) Patent Application Publication
(10) Pub. No.: US 2012/0164456 A1
(43) Pub. Date: Jun. 28, 2012

(54) Polyester Film for Protecting Polarizing Plate

(75) Inventors: Bo-Soo Seo, Gyeongsangbuk-do (KR); Sang-Won Seo, Gyeongsangbuk-do (KR); Chang-Ik Hwang, Daegu-si (KR); Sang-Pil Kim, Gyeongsangbuk-do (KR)

(73) Assignee: Toray Advanced Materials Korea Inc., Gyeongsangbuk-do (KR)

(21) Appl. No.: 13/233,813

(22) Filed: Sep. 15, 2011

(30) Foreign Application Priority Data
Dec. 23, 2010 (KR) 10-2010-0133344

(51) Int. Cl. B32B 27/18; B32B 27/36; G02B 5/30; B32B 27/08

(52) U.S. Cl. 428/419; 428/421; 428/422; 359/489.01

(57) ABSTRACT

A polyester film for protecting a polarizing plate is provided wherein the polyester film includes a polyester substrate film, and an anti-static layer provided on at least one surface of the polyester substrate film, the anti-static layer coated with an anti-static coating solution comprising a conductive polymer resin, a polyurethane resin, a cross linking agent and a fluoro resin wherein the anti-static coating solution comprises, on a basis of 100 parts by weight of the conductive polymer resin, about 100 to about 1,000 parts of the polyurethane resin, about 100 to about 2000 parts of the cross linking agent and about 30 to about 300 parts of the fluoro resin.

### CROSS-REFERENCE TO RELATED APPLICATION

This application claims the benefit of and priority to Korean Patent Application No. 10-2010-0133344, filed on Dec. 23, 2010, the disclosure of which is incorporated by reference in its entirety.

### FIELD

The following disclosure relates to a polyester film for protecting a polarizing plate. More particularly, this disclosure relates to a polyester film for a polarizing plate, capable of ensuring the accuracy of a test when testing a polarizing plate through crossed Nicols method, and improving transparency and anti-static performance while maintaining superior peel strength of a tape and anti-fouling property.

### BACKGROUND

In recent years, as mobile phones and personal computers are widely used, the demand for a liquid crystal display (LCD) having a small size, a thin thickness, a low power consumption and a high definition is growing and the development in a large scale LCD is also active. As an embodiment of the large screen LCD, an LCD for a 40 inch television has become popular. In order to implement a high brightness large scale LCD, the brightness of a backlight unit assembled inside an LCD may be increased or a film improving the brightness may be assembled with a backlight unit.

However, in such a large scale and high brightness type LCD, the brightness of a display screen tends to be adjusted to be further higher to improve the visibility, but this only causes a bright spot on the display. In addition, a sheet member assembled in the display, such as a polarizing plate, a retardation plate or a retardation polarization plate, is sensitive to alienate substances that do not usually exert on the performance of a conventional low brightness type LCD. Accordingly, there is a need for preventing alienate substances from being introduced to the LCD during a manufacturing process and a need for improving the accuracy of a test such that the introduced alienate substances are detected as a defect.

In general, a test for defects of a polarizing plate may be implemented by use of a visual testing through crossed Nicols method. Alternatively, a polarizing plate for a large scale TV having a size over 40 inches may be tested through an automatic alienate substance test apparatus using crossed Nicols method. Such a crossed Nicols method is performed by disposing two polarizing plates such that their main orientation axes cross each other to form a light extinction condition. If alienate substances or defects exist in the polarizing plate, a bright spot occurs in a predetermined position of the polarizing plate where the alienate substance or the defect exists, thereby detecting the process fault. In particular, a polarizing plate for a large display over 40 inches is subject to the automatic alienate substance test apparatus in a state that a polyester protection film is laminated to the surface of the polarizing plate. If an orientation angle of the polyester protection film is not appropriately controlled, the light extinction state is canceled out and a light leakage occurs. Accordingly, it is easy to fail to detect alienate substances and defects, leading to a process fault.

### SUMMARY

In one aspect, there is provided a polyester film for a polarizing plate, capable of ensuring the accuracy of a test when testing a polarizing plate through crossed Nicols method, and improving transparency and anti-static performance while maintaining superior peel strength of a tape and anti-fouling property.

In one general aspect, there is a polyester film for protecting a polarizing plate. The polyester film for protecting a polarizing plate comprises a polyester substrate film, and an anti-static layer provided on at least one surface of the polyester substrate film, the anti-static layer coated with an anti-static coating solution comprising a conductive polymer resin, a polyurethane resin, a cross linking agent and a fluoro resin.

In an embodiment, the anti-static coating solution comprises, on a basis of 100 parts by weight of the conductive polymer resin, about 100 to about 1,000 parts of the polyurethane resin, about 100 to about 2,000 parts of the cross linking agent and about 30 to about 300 parts of the fluoro resin. In another embodiment, the anti-static coating solution comprises 100 parts by weight of the conductive polymer resin, about 200 to about 300 parts of the polyurethane resin, about 200 to about 500 parts of the cross linking agent and about 100 to about 150 parts of the fluoro resin.

In another embodiment, the conductive polymer resin is a water dispersion of poly-anion and polythiophene or a water dispersion of poly-anion and polythiophene derivatives.

In yet another embodiment, the polyurethane resin is a water dispersible type and comprises at least one functional group selected from hydroxy group, amine group, carboxyl group, carbonyl group, hydroxy group, acrylic group, urethane group, amide group and imide group, carboxylic acid, maleic anhydride and maleic acid.

In yet another embodiment, the cross linking agent comprises at least one cross linking agent selected from the group consisting of isocyanate compound, carbonyl imide compound, oxazoline compound, melamine compound and aziridine compound.

In yet another embodiment, the fluoro resin is a tetrafluoroethylene resin.

In yet another embodiment, the anti-static coating solution has a solid content of about 0.5 to about 10 weight %.

In yet another embodiment, the anti-static coating solution is coated through an in-line coating method.

In yet another embodiment, the polyester substrate film is provided such that a main orientation axis of the polyester substrate film is inclined in a range of 3 degrees or less within a distance of 2 m of a widthwise direction of the polyester film, a refractive index at a direction perpendicular to the main orientation axis on a surface of the polyester film is 1.6400 or below, and a birefringence, which corresponds to a difference of refractive index between a direction of the main orientation axis and the direction perpendicular to the main orientation axis, is 0.050 or above.

At least one surface of the polyester film has a water contact angle of 80 degrees or above, a surface resistance of about 9.9×10⁹ Ω/sq, and the polyester film includes one or more layers each having a peel strength of a tape of 300 g/in or above.

In yet another embodiment, the polyester film satisfies Equation 1 as follows:

a≦b*30, Equation 1

wherein “b” represents a brightness measured when two polarizing plates are disposed in perpendicular to each other, and “a” represents a brightness measured when the polyester film is interposed between the two polarizing plates such that an orientation axis of one of the polarizing plates matches the main orientation axis of the polyester film.

As described above, a polyester film of this disclosure for a polarizing plate can ensure the accuracy of a test when testing a polarizing plate through crossed Nicols method, and improve transparency and anti-static performance while maintaining superior peel strength of a tape and anti-fouling property.

Other features will become apparent to those skilled in the art from the following detailed description, which, taken in conjunction with the attached drawings, discloses exemplary embodiments of the invention.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

A polyester film for protecting a polarizing plate according to an embodiment of the present invention comprises a polyester substrate film, and an anti-static layer provided on at least one surface of the polyester substrate film and coated with an anti-static coating solution. The anti-static coating solution comprises a conductive polymer resin, a polyurethane resin, a cross linking agent and a fluoro resin.

The polyester substrate film is formed using a composition of dicarboxylic acid and ethylene glycol diol. The dicarboxylic acid consisting of the polyester substrate film may be aromatic dicarboxylic acid, such as terephthalic acid, isophthalic acid, naphthalene dicarboxylic acid and o-phthalic acid, and aliphatic dicarboxylic acid, such as adipic acid, azelaic acid, sebacic acid and decanedicarboxylic acid. In addition, the diol consisting of the polyester substrate film may be aliphatic diols, such as ethylene glycol, propanediol, butanediol, neo-pentyl glycol, hexane diol, aliphatic diols such as, 1,4-cyclohexane dimethanol and aromatic diols. By performing generally known TPA method or DMT method using the above described composition, a polyester chip can be manufactured. The manufactured polyester chip is formed into a film through a following method. However, the method of forming a film is not limited thereto.

First, the polyester chip having the above composition is dried through a hopper drier, a paddle drier or a vacuum drier, and the dried polyester chip is melted at a temperature of about 200 to about 300° C. and then extruded in the form of a film. The extruding of the film is implemented through a T-die extruder and a tubular extruder. The extruded film is rapidly cooled and is formed in an unstretched film. The unstretched film is stretched in a longitudinal direction 2.0 to 5.0 times, preferably, 2.5 to 4.5 times, at a temperature of Tg or above but not exceeding Tg+15° C., preferably, at a temperature of Tg or above but not exceeding Tg+10° C. Thereafter, the film elongated in a longitudinal direction is stretched in a transverse direction 3.0 to 7.0 times, preferably, 3.5 to 6.5 times. The film elongated in the longitudinal direction and the transverse direction is subject to a thermal process at a temperature of about 200 to about 250° C. for a thermal shrinkage stability and thermal stability, thereby forming a polyester film.

The polyester substrate film according to an embodiment has a main orientation axis with a slope (an orientation angle) of 3° within a distance of 2 m of a widthwise direction of the polyester film, that is the transverse direction of the polyester film. If the orientation angle exceeds 3° within a distance of 2 m of the widthwise direction, an orientation axis of the polarizing plate is twisted with respect to the orientation axis of the polyester film. The twist of orientation axes causes a light leakage when the polarizing plate is tested through crossed Nicols method, thereby degrading the test result of the polarizing plate.

In addition, a refractive index of the polyester substrate film at a direction perpendicular to the main orientation axis on a surface of the polyester film is 1.6400 or below. If the refractive index of the direction perpendicular to the main orientation axis exceeds 1.6400, the amount of change of the orientation angle is increased, and this causes a difficulty in performing the crossed Nicols test. In addition, a birefringence of the polyester film has a 0.050 or above. A small birefringence below 0.050 may cause light reflection when a crossed Nicols test is performed on the two polarizing plates, disturbing the test and thus failing to detect alienate substances and defects.

Meanwhile, in order to ensure transparency of the substrate film, the substrate film may be formed by laminating two or more films, or particles of the coating solution may be provided only on a layer of the surface of the substrate film. The layer of the surface of the substrate film represents at least one of an outer layer and an inner layer.

In addition, the polyester film for protecting the polarizing plate includes an anti-static layer provided on at least one surface of the polyester substrate film. The anti-static layer is coated with an anti-static coating solution comprising a conductive polymer resin, a polyurethane resin, a cross linking agent and a fluoro resin. The anti-static coating solution is coated on the surface of the polyester substrate film and dried, thereby providing a polyester film having a superior transparency, solvent resistance, water repellency and anti-fouling property.

The composition of the anti-static coating solution is as follows:

(A) Conductive Polymer

A conductive polymer included in the anti-static coating solution is formed using a water dispersion of polyanion and polythiophene, or a water dispersion of a polyanion and polythiophene derivatives. The polyanion may be acidic polymer, for example, polycarboxylic acid, polysulfonic acid and polyvinyl sulfonic acid. The polycarboxylic acid may be polyacrylic acid, polymethacrylic acid and polymaleic acid. The polysulfonic acid may be polystyrene sulfonic acid. Preferably, the polyanion may have a higher ratio of weight percent solids to polythiophene or polythiophene derivatives in terms of conductivity. The polyanion may be more than about 1 weight % and less than about 5 weight % for about 1 weight % of polythiophene or polythiophene derivatives. More preferably, the polyanion may be equal to or more than about 1 weight % and equal to or less than about 5 weight %. One embodiment uses an aqueous dispersion of a polymer of a poly (3,4-ethylenedioxythiophene) of about 0.5 weight % and polystyrene sulfonic acid (molecular weight Mn=150,000) of about 0.8 weight %.

(B) Polyurethane Resin

The polyurethane resin included in the anti-static coating solution is used to improve the peel strength of the polyester film. Preferably, the polyurethane resin is a water dispersible type, and comprises at least one functional group selected from hydroxy group, amine group, carboxyl group, isocyanate group, epoxy group, and oxazoline group. The amount of the polyurethane resin added in the anti-static coating solution is about 100 to about 1,000 parts for 100 parts by weight of the conductive polymer resin. If less than about 100 parts of polyurethane resin is added to the anti-static coating solution, the peel strength may be degraded and not work appropriately. If more than about 1,000 parts of polyurethane resin is added to the anti-static coating solution, the peel strength is great enough, but the anti-static performance may be degraded or the water contact angle may be lowered. Accordingly, the polyester film is easily exposed to fouls such as alienate substances.

(C) Cross Linking Agent

The cross linking agent included in the anti-static coating solution is used to improve the solvent resistance between a coating layer serving as the anti-static layer and a polyester film corresponding to the substrate film. Preferably, the cross linking agent comprises at least one cross linking agent selected from the group consisting of isocyanate compound, carbonyl imide compound, aziridine compound, oxazoline compound and melamine compound. The amount of the cross linking agent added in the anti-static coating solution is about 100 to about 2,000 parts for 100 parts by weight of the conductive polymer resin. If less than about 100 parts of cross linking agent is added to the anti-static coating solution, the solvent resistance of the coating layer may be degraded. If more than about 2,000 parts of cross linking agent is added to the anti-static coating solution, the anti-static performance may be lowered.

(D) Fluoro Resin

The fluoro resin included in the anti-static coating solution is used to improve the anti-fouling property, the water contact angle and the solvent resistance of the coating layer. The fluoro resin may be polytetrafluoroethylene, tetrafluoroethylene, perfluoroalkyl vinyl ether copolymer, trifluoroethylene, hexafluoropropylene copolymer, tetrafluoroethylene copolymer, trifluoroethylene copolymer, polyvinyl fluoride, polyvinylidene fluoride, etc. Preferably, a tetrafluoroethylene resin is used. The amount of the fluoro resin added in the anti-static coating solution is about 30 to about 300 parts for 100 parts by weight of the conductive polymer resin. If less than about 30 parts of fluoro resin is added to the anti-static coating solution, the anti-fouling property is degraded. If more than about 300 parts is added to the anti-static coating solution, the transparency and the anti-static performance of the film are degraded.

The anti-static coating solution has a solid content of about 0.5 to about 10 weight % for 100 weight % of the entire coating solution. Preferably, the solid content is about 1.0 to about 5.0 weight %. If the solid content is less than about 0.5 weight %, a membrane of the coating layer is not formed and thus the coating layer fails to achieve suitable anti-static property. If the solid content is more than about 10 weight %, the transparence of the film is degraded and defects are generated on the coating layer.

Meanwhile, the solvent used in the anti-static coating solution is a water based coating solvent having water as a main medium. The coating solution may contain organic solvent in a predetermined range that does not impede the function of this embodiment. For example, isopropyl alcohol, butyl cellosolve, t-butyl cellosolve, ethyl cellosolve, acetone, ethanol, methanol, etc. However, in the case that the anti-static coating solution contains excessive amounts of organic solvent, if an in-line coating is used, explosion of the anti-static coating solution may occur during a drying process, a stretching process and a thermal process. Accordingly, the content of the organic solvent may be about 10 weight % or less in the anti-static coating solution to prevent the explosion. Preferably, the content of the organic solvent may be about 5 weight % or less in the anti-static coating solution.

As described above, the anti-static coating solution (a solid content of about 0.5 to about 10 weight %) obtained by mixing the conductive polymer resin, the polyurethane resin, the cross linking agent and the fluoro resin is coated on one surface or both surfaces of the polyester film and then dried, thereby proving a polyester protection film having a water repellency/anti-fouling property and anti-static property. The polyester protection film has a superior transparency, more than 80 degrees of a water contact angle representing a water repellency, a surface resistance value of 9.0×10⁹ Ω/sq or less and a peel strength of 300 g/in or above.

In addition, the polyester film for protecting a polarizing plate satisfies a first equation being shown below.

a≦b*30 Equation 1

wherein “b” represents a brightness measured when two polarizing plates are disposed in perpendicular to each other, and “a” represents a brightness measured when the polyester film is interposed between the two polarizing plates such that an orientation axis of one of the polarizing plates matches the main orientation axis of the polyester film.

Hereafter, features of the present invention will be described in detail through embodiments and comparative examples. However, the present invention is not limited to these embodiments.

### Embodiment

Manufacturing Polyester (A)

100 parts by weight of dimethyl terephthalic acid and 60 parts by weight of ethylene glycol are put in a reactor as starting material together with acetic acid magnesium salts serving as catalysis. From an initial reaction temperature of 150° C. of the reactor, the temperature increases while removing methanol through distillation. At the time lapse of three hours after initial reaction, the temperature of the reactor is 230° C. At the time lapse of four hours after initial reaction, the ester exchange reaction is finished in practice. Ethylic acid phosphate is added to the reaction mixture obtained through the ester exchange reaction, and the reaction mixture having the ethylic acid phosphate added is transferred to a polycondensation reactor, and then 0.04 parts by weight of antimony trioxide is added to the polycondensation reactor, and then a polycondensation is performed for four hours. That is, from the initial reaction temperature of 230° C., the temperature of the polycondensation reactor gradually increases to 280° C. Meanwhile, the pressure of the polycondensation reactor is slowly decreased from the atmospheric pressure to 0.3 mmHg. After the initial reaction of the polycondensation, when the limiting viscosity of the mixture reaches 0.625 dl/g with the change of the mixing power of the reactor, the polycondensation is finished. Thereafter, the polymer is extruded while applying nitrogen to obtain a polyester chip. The polyester chip offers a limiting viscosity of 0.625 dl/g.

Manufacturing Polyester (B)

Polyester (B) is obtained through the same method as the above method of manufacturing the polyester (A) except that an ethylene glycol slurry having particles of synthetic calcium carbonate is added after addition of the ethylic acid phosphate to form polyester (B). That is, ethylene glycol slurry having particles of synthetic calcium carbonate having a particle size of 0.8 μm and a particle distribution of 1.6 is added to the reaction mixture after the ethylic acid phosphate is added. In this case, the content of the ethylene glycol slurry is 1 weight % for the polyester. The obtained polyester (B) chip offers a limiting viscosity of 0.625 dl/g.

### Embodiments 1 to 3

A material obtained by mixing the polyester (A) chip and the polyester (B) chip in a ratio shown in Table 1 is used as a-layer material. A material having only the polyester (A) chip is used as b-layer material. The a-layer material and the b-layer material are provided from two extruders to form a laminated film having three layers consisting of a-layer, b-layer and a-layer. In this case, the a-layer material and the b-layer material are melt-extruded at the temperature of 290° C. Then, in a state that the a-layer forms the outer layer and the b-layer forms the inner layer, the extruded a-layer material and b-layer material are subject to cooling and solidification through a cooling roll (surface temperature of 40° C.) while using electrostatic attraction, thereby obtaining a unstretched sheet. Thereafter, the unstretched sheet is stretched in a longitudinal direction, that is, a machine direction (MD), with a MD stretch ratio shown in Table 1. A corona discharge is performed on one surface of the film. Thereafter, a coating solution prepared as shown in Table 1 is coated on the film by use of #5 Meyer Bar. Then, a transverse direction (TD) stretch and a thermal process is performed on the film under a process condition of a transverse direction stretch temperature, a transverse direction stretch ratio and the thermal process temperature shown in Table 1, so that a polyester film having a width of 1,000 mm is obtained. The obtained film has a total thickness of 38 μm, and the thicknesses of the a-layer, b-layer and a-layer sequentially laminated are 2 μm, 34 μm and 2 μm, respectively.

### Comparative Examples 1 to 5

A material obtained by mixing the polyester (A) chip and the polyester (B) chip in the ratio shown in Tables 2 and 3 is used as a-layer material. A material having only the polyester (A) chip is used as b-layer material. The a-layer material and the b-layer material are provided from two extruders to form a laminated film including three layers consisting of a-layer, b-layer and a-layer. The a-layer material and the b-layer material are melt-extruded at the temperature of 290° C. In a state that the a-layer forms the outer layer and the b-layer forms the inner layer, the extruded a-layer material and b-layer material are subject to cooling and solidification through a cooling roll (surface temperature of 40° C.) while using electrostatic attraction, thereby obtaining an unstretched sheet. Thereafter, the unstretched sheet is stretched in a longitudinal direction, that is, a machine direction (MD), with a MD stretch ratio shown in Tables 2 and 3. A corona discharge is performed on one surface of the film. Thereafter, a coating solution prepared as shown in Tables 2 and 3 is coated on the film by use of #5 Meyer Bar. Then, a transverse direction (TD) stretch and a thermal process is performed under a process condition of a transverse direction stretch temperature, a transverse direction stretch ratio and the thermal process temperature shown in Tables 2 and 3, so that a polyester film having a width of 1,000 mm is obtained. The obtained film has a total thickness of 38 μm, and the thicknesses of the a-layer, b-layer and a-layer sequentially laminated are 2 μm, 34 μm and 2 μm, respectively.

TABLE 1

| Item | | Embodiment 1 | Embodiment 2 | Embodiment 3 |
|---|---|---|---|---|
| Condition of | Ratio of a-layer | (A):(B) = 95:5 | (A):(B) = 90:10 | (A):(B) = 80:20 |
| material | material (wt %) | | | |
| Preparation | MD stretch ratio | 2.8 | 2.9 | 2.9 |
| condition of | MD stretch | 90 | 90 | 90 |
| film | temperature | | | |
| | TD stretch ratio | 5.4 | 5.2 | 5.0 |
| | TD stretch | 120 | 120 | 120 |
| | temperature | | | |
| | Thermal process | 195 | 200 | 200 |
| | temperature | | | |
| Coating | Conductive polymer | 100 | 100 | 100 |
| solution | resin | parts by weight | parts by weight | parts by weight |
| | (Bayer, Baytron P) | | | |
| | Polyurethane resin | 200 | 400 | 300 |
| | (Saitek, Daotan | parts by weight | parts by weight | parts by weight |
| | VTW 1236) | | | |
| | Melamine Cross | 200 | 300 | 500 |
| | linking agent | parts by weight | parts by weight | parts by weight |
| | (Saitek, CYMEL | | | |
| | 385) | | | |
| | Fluoride based | 100 | 150 | 100 |
| | compound | parts by weight | parts by weight | parts by weight |
| | (3M, FC-4430) | | | |
| | Surfactant (Il Shin | 2 | 2 | 2 |
| | Chemical Co., | parts by weight | parts by weight | parts by weight |
| | EXP4051) | | | |
| | Total solids (wt %) | 1.5 | 2.0 | 2.5 |
| Results | Orientation angle (°) | ∘ | ∘ | ∘ |
| | nβ | ∘ | ∘ | ∘ |
| | ^{Δ}n | ∘ | ∘ | ∘ |
| | Surface | 10⁶ | 10⁶ | 10⁶ |
| | resistance(Ω/sq) | | | |
| | Water contact angle | 101 | 106 | 98 |
| | (degrees) | | | |
| | Peel strength (g/in) | 388 | 351 | 438 |
| | Visual testing | ∘ | ∘ | ∘ |

TABLE 2

| | | Comparative | Comparative | Comparative |
|---|---|---|---|---|
| Item | | example 1 | example 2 | example 3 |
| Condition | Ratio of a-layer | (A):(B) = 95:5 | (A):(B) = 90:10 | (A):(B) = 80:20 |
| of material | material (wt %) | | | |
| Preparation | MD stretch ratio | 3.1 | 3.3 | 3.3 |
| condition | MD stretch | 90 | 90 | 90 |
| of film | temperature | | | |
| | TD stretch ratio | 4.0 | 3.8 | 3.3 |
| | TD stretch | 120 | 120 | 120 |
| | temperature | | | |
| | Thermal process | 240 | 240 | 240 |
| | temperature | | | |
| Coating | Conductive polymer | 100 | 100 | 100 |
| solution | resin | parts by weight | parts by weight | parts by weight |
| | (Bayer, Baytron P) | | | |
| | Polyurethane resin | 200 | 400 | 300 |
| | (Saitek, Daotan | parts by weight | parts by weight | parts by weight |
| | VTW 1236) | | | |
| | Melamine Cross | 200 | 300 | 500 |
| | linking agent (Saitek, | parts by weight | parts by weight | parts by weight |
| | CYMEL 385) | | | |
| | Fluoride based | 100 | 150 | 50 |
| | compound | parts by weight | parts by weight | parts by weight |
| | (3M, FC-4430) | | | |
| | Surfactant (Il Shin | 2 | 2 | 2 |
| | Chemical Co., | parts by weight | parts by weight | parts by weight |
| | EXP4051) | | | |
| | Total solids (wt %) | 1.5 | 2.0 | 2.5 |
| Results | Orientation angle (°) | X | X | X |
| | nβ | X | X | X |
| | ^{Δ}n | X | X | X |
| | Surface | 10⁶ | 10⁶ | 10⁶ |
| | resistance(Ω/sq) | | | |
| | Water contact angle | 101 | 106 | 98 |
| | (degrees) | | | |
| | Peel strength (g/in) | 388 | 351 | 438 |
| | Visual testing | X | X | X |

TABLE 3

| | | Comparative | Comparative |
|---|---|---|---|
| Item | | example 4 | example 5 |
| Condition | Ratio of a-layer | (A):(B) = | (A):(B) = |
| of material | material (wt %) | 95:5 | 90:10 |
| Preparation | MD stretch ratio | 3.1 | 3.4 |
| condition | MD stretch temperature | 90 | 90 |
| of film | TD stretch ratio | 3.5 | 3.6 |
| | TD stretch temp. | 120 | 120 |
| | Thermal process temperature | 240 | 240 |
| Coating | Conductive polymer resin | 20 | 100 |
| solution | (Bayer, Baytron P) | parts by weight | parts by weight |
| | Polyurethane resin | 0 | 100 |
| | (Saitek, Daotan VTW 1236) | parts by weight | parts by weight |
| | Melamine Cross linking agent | 100 | 100 |
| | (Saitek, CYMEL 385) | parts by weight | parts by weight |
| | Fluoride based compound | 50 | 0 |
| | (3M, FC-4430) | parts by weight | parts by weight |
| | Surfactant (Il Shin | 2 | 2 |
| | Chemical Co., EXP4051) | parts by weight | parts by weight |
| | Total solids (wt %) | 1.0 | 1.5 |
| Results | Orientation angle (°) | X | X |
| | nβ | X | X |
| | ^{Δ}n | X | X |
| | Surface resistance(Ω/sq) | 10¹⁴ | 10⁶ |
| | Water contact angle (degrees) | 93 | 51 |
| | Peel strength (g/in) | 61 | 357 |
| | Visual testing | X | X |

Physical characteristic are measured through following experiment examples using polarizing plate protection polyester films according to Embodiments 1 to 3 and Comparative

### Examples 1 to 5

### Experiment Example

(1) Measuring the Limiting Viscosity of Polyester:

Polyester (1 g) is accurately measured, the measured polyester dissolves in a mixing solution of 100 mL having a mixing ratio of phenol to tetrachloroethane at 50:50, and the limiting viscosity of the polyester is measured at the temperature of 30° C.

(2) Orientation Angle:

The positions of ends and the center of a A4 size (210×297 mm) area of the manufactured film are sampled within a distance of 2 m of the width direction of the manufactured film, and then the orientation angle is measured for each position by use of a molecular orientation analyzer (MOA).

∘: 3 degrees or less of an orientation angle

X: over 3 degrees of an orientation angle

(3) Refractive Index of a Direction Perpendicular to a Main Orientation Axis of the Film(nβ):

The positions of the ends and the center of a A4 size area of the manufactured film are sampled, and the refractive index of a direction perpendicular to the main orientation axis on the surface of the film is measured by use of ATAGO OPTICS CO., LTD, Abbe refractometers for each position. Then, the average refractive index is obtained as n13.

∘: 1.6400 or less of refractive index (nβ)

X: over 1.6400 of refractive index (nβ)

(4) Birefringence:

The positions of the ends and the center of a A4 size area of the manufactured film are sampled, and the birefringence for each position is obtained as an absolute value of the difference between a refractive index (nx) of the width direction of the film and a refractive index (ny) of a direction perpendicular to the width direction through the following equation.

Δn=1(nx)−(ny)1 Equation 2

∘: 0.05 or more of birefringence (Δn)

X: less than 0.050 of birefringence (Δn)

(5) Water Contact Angle:

A sessile drop method is performed on a coating surface of the manufactured film by use of water purified through ion exchanged water distillation and then the water contact angle on the coating surface is measured by use of a contact angle measuring device (Kyowa Interface Science). The water contact angle is measured five times and then the average of each water contact angle is taken.

(6) Surface Resistance:

The surface resistance is measured at a coating surface of the manufactured film by use of a surface resistivity tester (Mitsubishi Corporation) based on JIS K7149 at a measuring condition of the temperature of 23° C. and the relative humid of 45%. The surface resistance is measured five times and then the average of each surface resistance is taken.

(7) Peel Strength of a Tape:

By use of a peel strength measuring device AR1000 (Chem Instruments), at a measuring condition of the temperature of 23° C. and a relative humid of 45%, the peel strength is measured by attaching a tape having a thickness of 25 μm and a width of 25 μm (N0.31B, Nitto Denko corporation) to a coating surface of the manufactured film, compressing the attached tape by rolling a rubber roller having a weight of 2 kg back and forth one time on the tape attached to the coating surface and then separating the tape at a speed of 0.3 mpm with an angle of 180 degrees.

(8) Availability of Visual Testing:

An area having a height of 10 cm and a width of 10 cm is sampled from the manufactured film, and the sample is interposed between two polarizing plates, orientation axes thereof perpendicular to each other. In a state the longitudinal direction of the biaxially stretched polyester film is matched to an orientation axis of one of the two polarizing plates, the brightness is measured at nine points spaced apart from each other by a predetermine interval in the sample by use of Konica Minolta CA2000, and then the average (a) of each brightness is obtained. With respect to an average brightness (b) that is measured from two polarizing plates perpendicular to each other, the availability of visual testing is evaluated as follows.

∘: ≦b*30

X: a>60

As described above, the polyester film for protecting a polarizing plate according to the present invention can ensure the accuracy of a test when testing a polarizing plate by use of crossed Nicols method, and improve transparency and anti-static performance while maintaining superior peel strength of a tape and anti-fouling property.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A polyester film for protecting a polarizing plate, the polyester film comprising:
a polyester substrate film; and
an anti-static layer provided on at least one surface of the polyester substrate film, the anti-static layer coated with an anti-static coating solution comprising a conductive polymer resin, a polyurethane resin, a cross linking agent and a fluoro resin.

2. The polyester film for protecting a polarizing plate of claim 1, wherein the anti-static coating solution comprises, on a basis of 100 parts by weight of the conductive polymer resin, about 100 to about 1,000 parts of the polyurethane resin, about 100 to about 2,000 parts of the cross linking agent and about 30 to about 300 parts of the fluoro resin.

3. The polyester film for protecting a polarizing plate of claim 1, wherein the conductive polymer resin is a water dispersion of poly-anion and polythiophene or a water dispersion of poly-anion and polythiophene derivatives.

4. The polyester film for protecting a polarizing plate of claim 1, wherein the polyurethane resin is a water dispersible type and comprises at least one functional group selected from hydroxy group, amine group, carboxyl group, carbonyl group, hydroxy group, acrylic group, urethane group, amide group and imide group, carboxylic acid, maleic anhydride and maleic acid.

5. The polyester film for protecting a polarizing plate of claim 1, wherein the cross linking agent comprises at least one cross linking agent selected from the group consisting of isocyanate compound, carbonyl imide compound, oxazoline compound, melamine compound and aziridine compound.

6. The polyester film for protecting a polarizing plate of claim 1, wherein the fluoro resin is a tetrafluoroethylene resin.

7. The polyester film for protecting a polarizing plate of claim 1, wherein the anti-static coating solution has a solid content of about 0.5 to about 10 weight %.

8. The polyester film for protecting a polarizing plate of claim 1, wherein the anti-static coating solution is coated through an in-line coating method.

9. The polyester film for protecting a polarizing plate of claim 1, wherein the polyester substrate film is provided such that a main orientation axis of the polyester substrate film is inclined in a range of 3 degrees or less within a distance of 2 m of a widthwise direction of the polyester film, a refractive index at a direction perpendicular to the main orientation axis on a surface of the polyester film is 1.6400 or below, and a birefringence, which corresponds to a difference of refractive index between a direction of the main orientation axis and the direction perpendicular to the main orientation axis, is 0.050 or above.

10. The polyester film for protecting a polarizing plate of claim 1, wherein at least one surface of the polyester film has a water contact angle of 80 degrees or above, a surface resistance of about 9.9×10⁹ Ω/sq, and the polyester film includes one or more layers each having a peel strength of a tape of 300 g/in or above.

11. The polyester film for protecting a polarizing plate of claim 1, wherein the polyester film satisfies Equation 1 as follows:
a≦b*30, Equation 1
wherein “b” represents a brightness measured when two polarizing plates are disposed in perpendicular to each other, and “a” represents a brightness measured when the polyester film is interposed between the two polarizing plates such that an orientation axis of one of the polarizing plates matches the main orientation axis of the polyester film.

12. The polyester film for protecting a polarizing plate of claim 1, wherein the anti-static coating solution comprises 100 parts by weight of the conductive polymer resin, about 200 to about 300 parts of the polyurethane resin, about 200 to about 500 parts of the cross linking agent and about 100 to about 150 parts of the fluoro resin.

13. The polyester film for protecting a polarizing plate of claim 12, wherein the anti-static coating solution further comprises surfactant.
